(19) United States
(12) Patent Application Publication
(10) Pub. No.: US 2012/0126067 A1
(43) Pub. Date: May 24, 2012

(54) CABLE ROUTING DEVICE

(76) Inventors: Frank Chauzu, Obernai (FR); René Chauzu, Suce sur Erdre (FR)

(21) Appl. No.: 13/359,589

(22) Filed: Jan. 27, 2012

Related U.S. Application Data
(63) Continuation-in-part of application No. 12/664,896, filed on Dec. 16, 2009.

(30) Foreign Application Priority Data
Jun. 20, 2007 (FR) 0704390

(51) Int. Cl. F16L 3/22

(52) U.S. Cl. 248/49

(57) ABSTRACT

Device for routing cables, more particularly intended for routing and distributing electric cables having an elongated shape (1) with a U-shaped cross-section including an assembly of two side posts (3) forming the arms of the U and of a base (2) forming the bottom of the U. The side posts (3) and the base (2) are made from a composite material and/or a strengthened plastic material and in that at least one side post (3) is pivotally mounted while being jointed to the base (2) about an axis of rotation (30) by at least one hinge (4) and in that it comprises snap-coupling devices (35,26,63,7) and abutment devices (22,23,38,29,27) capable of locking the side post perpendicularly to said base (2) under the action of its rotation.

### CROSS REFERENCE TO RELATED APPLICATION

This application is a continuation-in-part of U.S. patent application Ser. No. 12/664,896 filed Dec. 16, 2009, pending, which is a national stage entry of PCT/FR2008/000827 filed Jun. 16, 2008, under the International Convention claiming priority over French Application No. 0704390 filed Jun. 20, 2007.

### FIELD OF THE INVENTION

The present invention is a device for routing cables, more particularly intended for routing and distributing electric cables.

### BACKGROUND OF THE INVENTION

Present cable routings comprise an elongated structure with a U-shaped cross-section, inside which the cables are laid and optionally attached, and either made from an assembly of metal components forming a base and side posts, commonly called <<cable ladders>>, intended to support cables with a weight of the order of 100 kg/m with supporting distances of the order of 3-4 meters, or as a one-piece structure in solid or open worked metal sheet or else further in welded wire-mesh, commonly called <<cable routes>>, intended to support cables of a weight of the order of 30 kg/m with supporting distances of the order of 1 to 2 meters.

These structures include several constitutive components connected end to end, generally installed horizontally and having sufficient rigidity in order to support the weight of the cables, without excessive flexure.

However, these cable routing devices occupy a significant volume during their storage and their transport up to the area of their installation, which causes high logistic costs.

In order to find a remedy to these drawbacks, wire-mesh devices for routing metal cables are known, the side posts of which devices are jointed to the base of the structure in order to be able to place the cable route in a planar or L-shaped configuration for its storing by stacking the structures over each other or in a U-shaped configuration, i.e. with posts perpendicular to the base for its installation on site.

However in order to maintain the cable route jointed in its U-shaped configuration with view to installing it on site, it is necessary to manually place or actuate right-angled or ring-shaped blocking components at each mesh of the wire mesh between the side posts and the base which makes the operation tedious and costly in assembly time.

Additionally, metal cable routing devices have a great weight and may have sharp edges, after cutting, which damage the cables or injure the installers. Moreover, they are electrically conductive, which imposes that each component of the cable routing device be connected to the ground which considerably increases the installation costs.

### SUMMARY OF THE INVENTION

The object of the present invention is to find a remedy to these drawbacks by proposing a cable routing device substantially made from synthetic materials and allowing easy and rapid transformation of the cable routing device from a planar or L-shaped configuration beneficial for its making or for its storage and its transport into a U-shaped configuration for its installation on site.

The cable routing device according to the present invention is more particularly intended for routing and distributing electric cables and has an elongated shape with a U-shaped cross-section including an assembly of two side posts forming the arms of the U and a base forming the bottom of the U, the side posts and the base being substantially made from a composite material and/or a strengthened plastic material; the cable routing device according to the present invention is essentially characterized in that:

at least one side post includes a longitudinal portion having an at least partially circular cross-section and includes windows, a first edge of said windows adjacent said longitudinal portion being delineated by said longitudinal portion;

said base including side extensions each forming rounded hooks intended to be pivotally mounted around said longitudinal portion, so that said longitudinal portion forms an axis of rotation for said side post between a first position in which said side post is substantially coplanar with said base and a second position in which said side post is substantially perpendicular to said base, said longitudinal portion and hooks thus forming a multiplicity of hinges; and

each of said windows is dimensioned so as to tightly receive one hook therein when said side post is in said second position.

In the present invention the term “tightly receive” means that each of said window has a second edge opposite said first edge and third and fourth edges opposite one another, perpendicular to said first and second edges, that are close to said hook when said hook is engaged onto said longitudinal portion and said side post is in said second position. The term “Close” means less than ten millimeters and generally less that five millimeters and preferably less than two millimeters.

A hinge will thus consist of a side extension of the base hemmed into a window made in the side post, joined together around the axis of rotation, allowing rotation of the pivoting side post.

According to another feature of the present invention, said base has a first side, on which said side post extends when said side post is in said second position, and a second side opposite said first side, and each hook comprises a rounded portion delineating a space adapted for the engagement of said hook onto said longitudinal portion, this space opening on said second side of the base.

According to another feature of the present invention, each hook comprises a rounded portion extending over more than 180° from a base portion by which said rounded portion is attached to said base, to a free end opposed to said base portion, said rounded portion being adapted to be engaged by snap-coupling on said longitudinal portion for securing said side post to said base.

According to another feature of the present invention, the cable routing device comprises snap-coupling devices and abutment devices capable of locking said side post in said second position.

Said abutment devices can include at least one blocking abutment forming an obstacle to the rotation of the pivoting side post preventing its rotation beyond an angle of about 90° with the base and at least one antireturn abutment which will engage by snap-coupling the snap-coupling devices and preventing the rotation of the side post upon opening.

In a first embodiment of the snap-coupling devices, the latter comprises first notches arranged on the surface of said rounded portion of said hook delineating said space adapted for the engagement of said hook onto said longitudinal portion, and second notches arranged on the surface of said longitudinal portion, said first and second notches being intended to be snapped onto each other as said side post gradually rotates toward said second position, thus blocking said side post in an angular position.

In a second embodiment of the snap-coupling devices, the latter comprise at least one flexible flexural tab connected to said side post and an anti-return abutment surface on said base, said flexible flexural tab being capable to elastically flex so as to slide over said anti-return abutment surface when said side post is moved toward said second position and to engage by snap-coupling against said anti-return abutment surface when said side post is in said second position.

Thus, during the rotation of the side post, when the latter forms an angle of about 90° with the base, said tab is subject, without breaking, to an elastic deformation and will engage by snap-coupling of its free edge against the surface of an anti-return abutment.

The tab may be positioned relatively to its free edge so as to operate in compression or in traction.

In a first embodiment of a side post, the latter is a single profile piece.

In a second embodiment of a side post, the latter includes at least two rods and connecting parts for rigidly connecting said rods.

The connecting parts may be overmolded on the rods or welded around the rods.

The rods will preferably made by profile-shaping from a composite material reinforced with continuous fibers while the connecting parts will be made by molding from a plastic material either reinforced or not with discontinuous fibers.

According to another feature of the present invention, said rounded portion of each hook tapers from a base part of said rounded portion connected to said base to a free end of said rounded portion, and said base part is larger and/or thicker than a window of said side post, thus allowing a play between said rounded portion and said window when said side post is in said first position and performing a tightening without any play between said rounded portion and said window when said side post is in said second position.

According to one embodiment, each connecting part may include a window which will be extended with a cage in the form of an inverted U, the arms of which will be flared and will clasp the side extensions so that the phase for engaging the side extensions into the cage is accomplished with play and that the tightening between said arms and the side extensions increases as the pivoting side post gradually rotates so as to become total and without any play when the angle of the pivoting side post is close to 90° with the base corresponding to the snap-coupling angle blocking the pivoting post perpendicularly to said base.

In a first embodiment of the base, the latter is an assembly made in a single piece, either solid or open worked.

In a second embodiment of the base, the latter consists of a succession of bars perpendicular to the longitudinal axis of the cable route and the side extensions of the base are formed by the free ends of said bars.

The bars may be made in a single piece by compression- or injection-molding, or by assembling a body-forming portion and at least one added end portion forming the side extension. The bars will advantageously include orifices intended for attaching the cables.

The bars may include side stabilizers bearing upon a surface of the pivoting side post allowing the bars to be blocked perpendicularly to the longitudinal axis of the cable route and preventing any longitudinal deformation of the latter during use.

The bars may have an omega-shaped cross-section, the two side legs of which may advantageously form at the end of the bars supporting surfaces intended to come into contact with a surface of the side post.

### BRIEF DESCRIPTION OF THE DRAWINGS

The advantages and the characteristics of the present invention will become more clearly apparent from the description which follows and which relates to the appended drawings which illustrate non-limiting embodiments thereof.

FIG. 1 illustrates a perspective view of a cable route in one embodiment of the side posts by assembly according to the present invention,

FIG. 2 illustrates a perspective view of a cable route according to the present invention in the embodiment of FIG. 1 in the assembling situation,

FIG. 3 illustrates a perspective view of a bar forming the base of the cable routing according to the present invention,

FIG. 4 illustrates a cross-sectional view of a cable routing according to the present invention as illustrated in FIG. 1,

FIG. 5 illustrates a perspective view of a bar in the upside-down position of a cable route according to the present invention, provided with notches at its free hook-shaped ends,

FIG. 6 illustrates a cross-sectional view of a cable route according to the present invention provided with a bar as described in FIG. 5,

FIG. 7 illustrates a perspective view of a side post of a cable route according to the present invention in an embodiment of the side posts made in a single piece,

FIG. 8 illustrates a cross-sectional view of the cable route according to the present invention illustrated in FIG. 7,

FIG. 9 illustrates a perspective view of the cable route described in FIG. 8 in the assembling situation substantially coplanar,

FIG. 10 illustrates a perspective view of a cable route described in FIG. 7 in an alternative of one of the longitudinal edges of the side posts,

FIG. 11 illustrates a perspective view of a bar provided with a snap-coupling lug at each of its free ends.

### DETAILED DESCRIPTION OF THE INVENTION

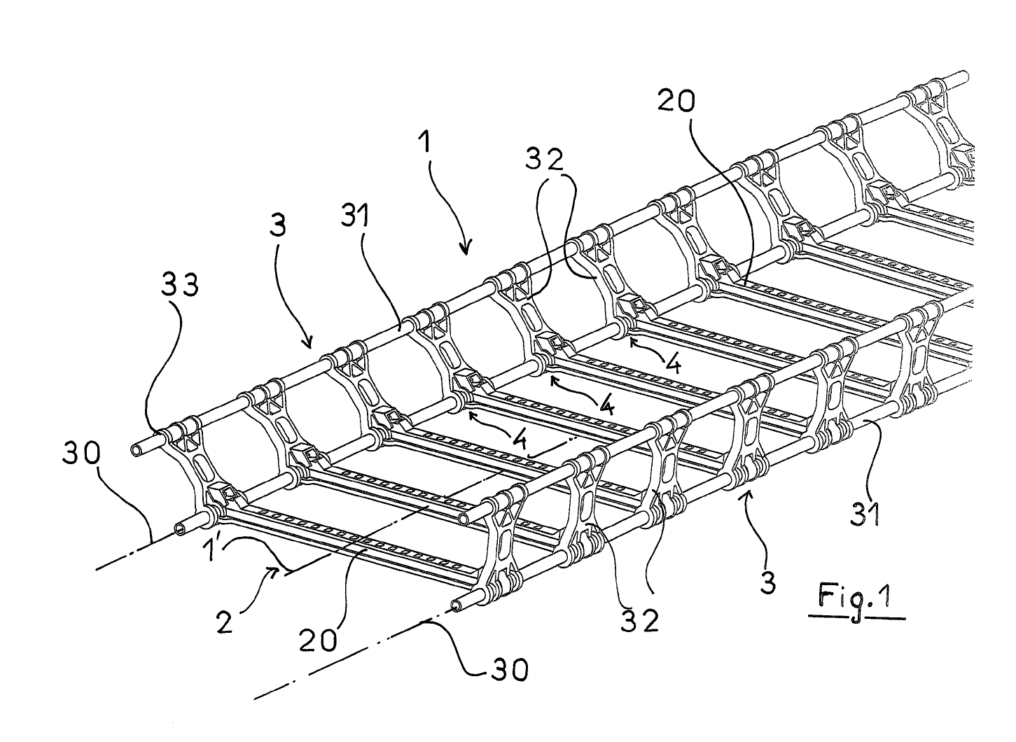

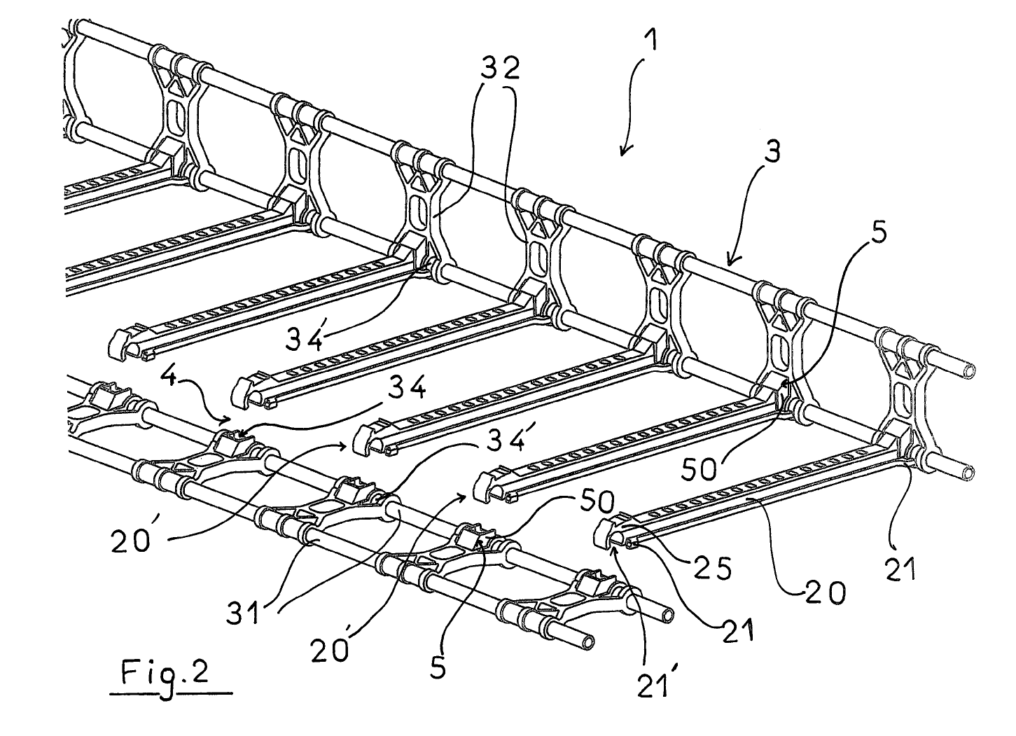

If reference is made to FIG. 1 and to FIG. 2, it may be seen that a cable routing device according to the present invention has a structure 1 with an elongated shape with a U-shaped cross-section and comprises a base 2 and two side posts 3, substantially made from a composite material or a reinforced plastic material.

The side posts 3 are pivotally mounted about an axis of rotation 30, parallel to the longitudinal axis 1′ of the cable route, defining the junction line between the base 2 and the side posts 3. In order to ensure pivoting of the side posts 3 relatively to the base 2, hinges 4 are firmly secured along the side walls of the base 2 and form a multiplicity of jointing points between the side posts 3 and the base 2.

It may be seen that the base 2 consists of a succession of bars 20, regularly spaced out, perpendicular to the longitudinal axis 1′ of the cable route 1 and to the axis of rotation 30, which bars 20 are firmly secured to the side posts 3 by their free ends 20′.

According to the first embodiment shown of FIGS. 1 and 2, a side post 3 consists of two parallel rods 31 preferably made in a composite material and connected to each other through connecting parts 32 with a globally rectangular shape, regularly spaced out and located in the plane formed by the two straight rods 31. A connecting part 32 is made from a reinforced plastic material and includes at each of its ends, a transverse orifice 33 intended to respectively receive the straight rods 31, one of which materializes the axis of rotation 30 of the side post 3 with the base 2.

It may also be seen that each connecting part 32 includes, at the transverse orifice intended to be crossed by the rod 31 forming the axis of rotation 30 of the side post 3, a window 34 with which the corresponding free end 20′ of a bar 20 may be hemmed into a window 34 around the rod 31 so as to ensure the joint between the base 2 and the side post 3 and to limit the possibilities of longitudinal movement of said base relative to said side post.

More specifically, each window 34 has a first edge adjacent said rod 31, formed by this rod 31, a second edge opposite said first edge and third and fourth edges opposite one another, perpendicular to said first and second edges.

It will be noted that the connecting parts 32 have a recessed geometry intended for saving material while providing preferential hooking-up areas for attaching electric accessories such as distribution boxes. Moreover they have a width, in the longitudinal direction of the cable routing, sufficient for ensuring a not very deformable rigid connection between the rods 31 and which has the effect of reducing the distance between two consecutive connecting parts 32 thereby limiting the deformations undergone by the rods 31 when the cable route is under load.

In said first embodiment, each window 34 is bounded by an inverted U-shaped portion capable to engage on a corresponding bar 20, straddling it.

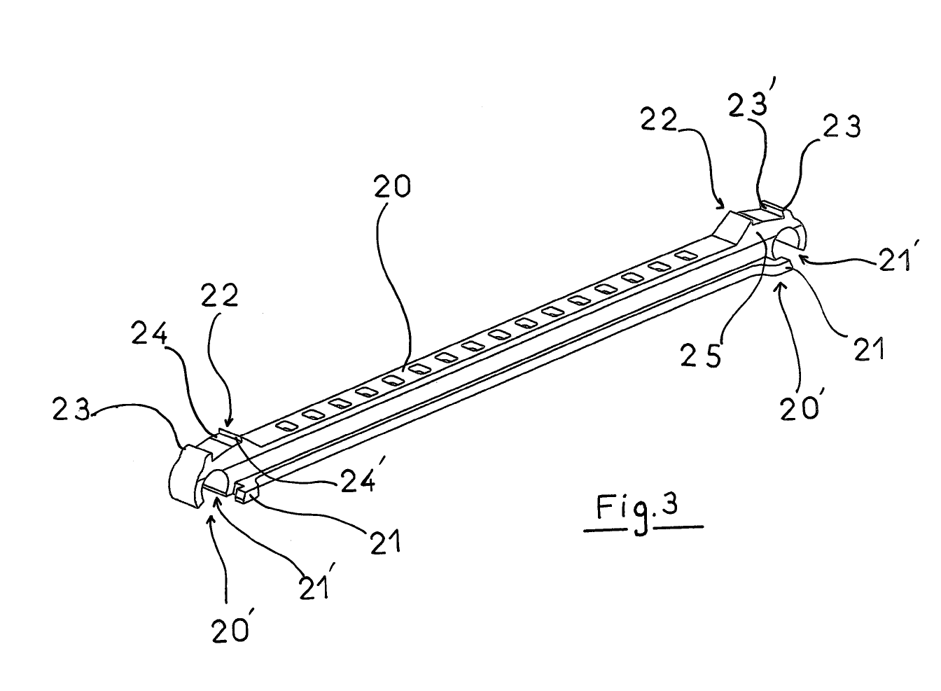

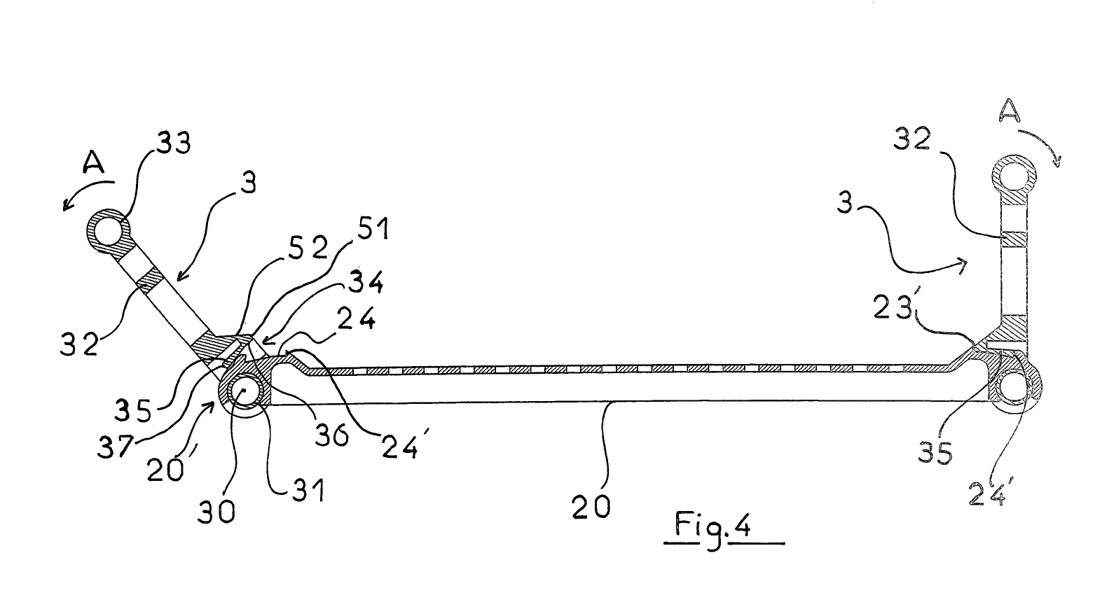

If reference is now made to FIG. 3 and FIG. 4, it may be seen that a bar 20 includes two free rounded hook-shaped ends 20′, intended to be engaged during the assembling, as this may also be seen in FIG. 2, into the window 34 of the corresponding connecting part 32 around the axis of rotation 30 formed by a section of the rod 31 crossing the window 34 of the connecting part 32.

In other words, said base 2 includes side extensions each forming rounded hooks 20′ intended to be pivotally mounted around said rod 31, so that said rod 31 forms an axis of rotation for said side post 3 between a first position in which said side post 3 is substantially coplanar with said base 2 and a second position in which said side post 3 is substantially perpendicular to said base 2, said rod 31 and hooks 20′ thus forming a multiplicity of hinges.

Said base 2 has a first side, on which said side post 3 extends when said side post 3 is in said second position, and a second side opposite said first side, and each hook 20′ comprises a rounded portion delineating a space 21′ adapted for the engagement of said hook onto said rod 31, this space 21′ opening on said second side of the base 2.

Said rounded portion extends from a base portion by which said rounded portion is attached to said base, up to a free end opposed to said base portion and the inner surface thereof delineating said space 21 is a circular surface extending over more than 180°. Said rounded portion is thus adapted to be engaged by snap-coupling on said rod 31 for securing said side post 3 to said base 2.

An end 20′ includes two side stabilizers 21 capable of bearing against the connecting part 32 on either side of the window 34 in annular grooves 34′ preventing any side tilt of the bar 20, notably under the effect of external stresses when the electric cables are placed and drawn, which avoids any longitudinal deformation of the installed cable route 1.

Each of said windows 34 is dimensioned so as to tightly receive one hook therein when said side post 3 is in said second position. The term “tightly receive” means that said first, second, third and fourth edges are close to said hook when said hook is engaged onto said rod 31 and said side post 3 is in said second position. The term “Close” means less than five millimeters and generally less that two millimeters.

It may also be seen that the upper external face of an end 20′ of a bar 20 includes two internal 22 and external 23 abutments, the external abutment 23 consisting of a vertical wall 23′ perpendicular to the longitudinal axis of the bar 20 and to the plane containing the base 2 and the internal abutment 22 consisting of a horizontal surface 24 parallel to the longitudinal axis of the bar 20 and of a vertical surface 24′ which will reinforce the abutment function of the horizontal surface 24.

The internal abutment 22 is an obstacle to rotation of the side post 3, preventing its rotation beyond an angle of 90° with the base 2 when a supporting surface 36 of the connecting parts 32 will abut against the horizontal surface 24 of the internal abutment 22.

The external abutment 23 is an anti-return abutment intended to receive by snap-coupling, when the side post 3 pivots towards the base 2 and is in an angular position of about 90° with the base 2, a supporting surface 37 of a connecting part 32 preventing rotation of the side post upon opening with the base 2, i.e. towards the outside of the cable route as indicated by A.

The supporting surface 37 is formed by the end surface of a tab 35, flexible in flexure and resistant to buckling, made in the window 34 of a connecting part 32 substantially perpendicular the plane of the connecting part 32. The tab 35 is intended to engage by snap-coupling onto the external abutment 23.

It may also be seen that a window 34 made in a connecting part 32 extends with a cage 5 in the shape of an inverted U and the arms 50 of which are flared and clasp the side walls 25, themselves also flared according to an identical tilt, from the ends 20′ of the bars 20 so that the engagement phase of the ends of the bars into the cage is accomplished with play and that tightening between said arms 50 and the side walls 25 is gradual upon rotating the side post 3, becoming total and without play when the angle of the latter is close to 90° with the base 2 upon snapping on the tab 35 thereby suppressing any side movement of the bars 20 after snap-coupling.

The tab 35 is secured at one of its ends to the front edge of the base of the U forming the roof 52 of the cage 5, the external surface of the front edge 51 forming an abutment surface intended to come into contact with the vertical surface 24′ of the internal abutment 22 of the corresponding bar 20 in order to reinforce blocking of rotation beyond an angle of 90° between the side post 3 and the base 2.

A side post 3 from a mechanical point of view, because of the properties of the different selected materials, composite and reinforced plastic material, of their geometry and positioning, thus forms a vertical flexural rigid recessed beam having a much greater inertia than the sum of the inertias of the components which make it up. However a post made in this way retains relative side flexibility allowing the cable routes to adapt by slight deformation to the installation stresses on site. Moreover with this combination of materials from different manufacturing methods, it is possible to obtain both flexible areas 35 able to deform by snap-coupling while globally retaining great rigidity of the side posts 3 because of the straight rods 30 made from a pultruded composite material and localized at the locations of the largest mechanical stresses to which the cable route is subject under load.

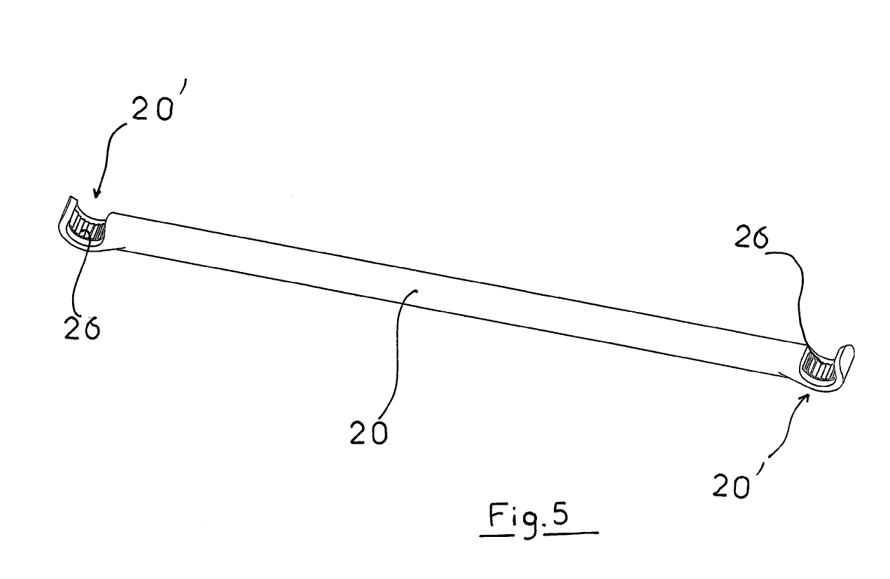

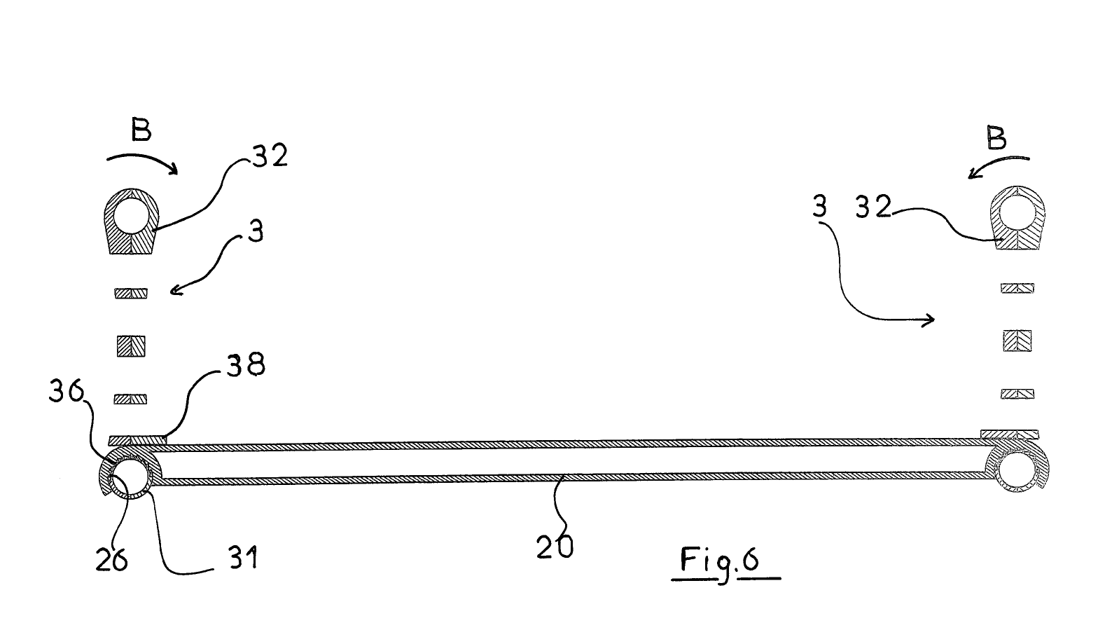

If reference is made to FIG. 5 and to FIG. 6, a bar 20 may be seen, the hook-shaped ends 20′ of which are engaged on a round rod 31 and include on their internal face a series of notches 26 intended to cooperate with mating notches 36 made on the external face of the axis of rotation 31 so as to form a circular rack, the notches 26, 36 of which will snap into each other as the side post 3 gradually rotates towards the inside of the structure 1, in the B direction, blocking at each index of rotation, said side post 3 in a given angular position until the angle between the pivoting side post 3 and the base 2 is equal to about 90°. It may also be seen that a window 34 made in a connecting part 32 includes at its upper edge a strip 38 which extends perpendicularly to the connecting part 32 and which is intended to bear against the external surface of the base 2 when the side post 3 reaches an angle of 90° with the base 2 preventing the side post 3 from pivoting beyond this angle towards the inside of the structure 1 while the notches 26, 36 prevent the side post 3 from pivoting in the opposite direction towards the outside of the structure 1.

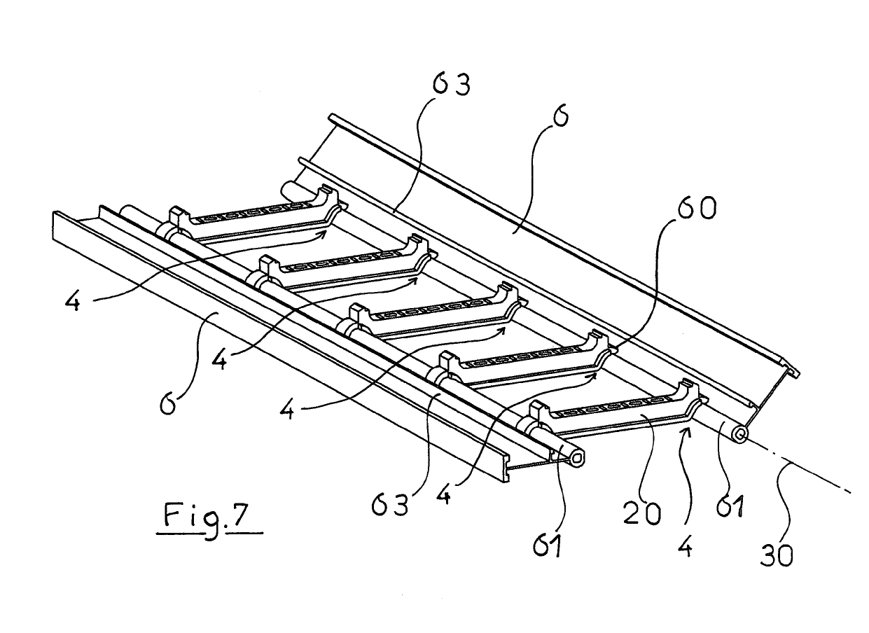

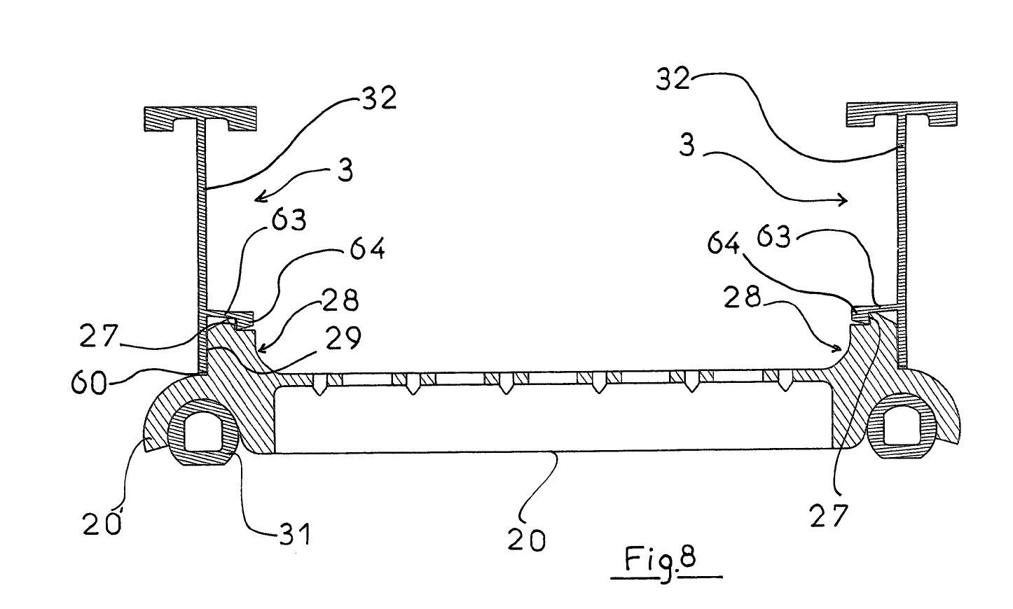

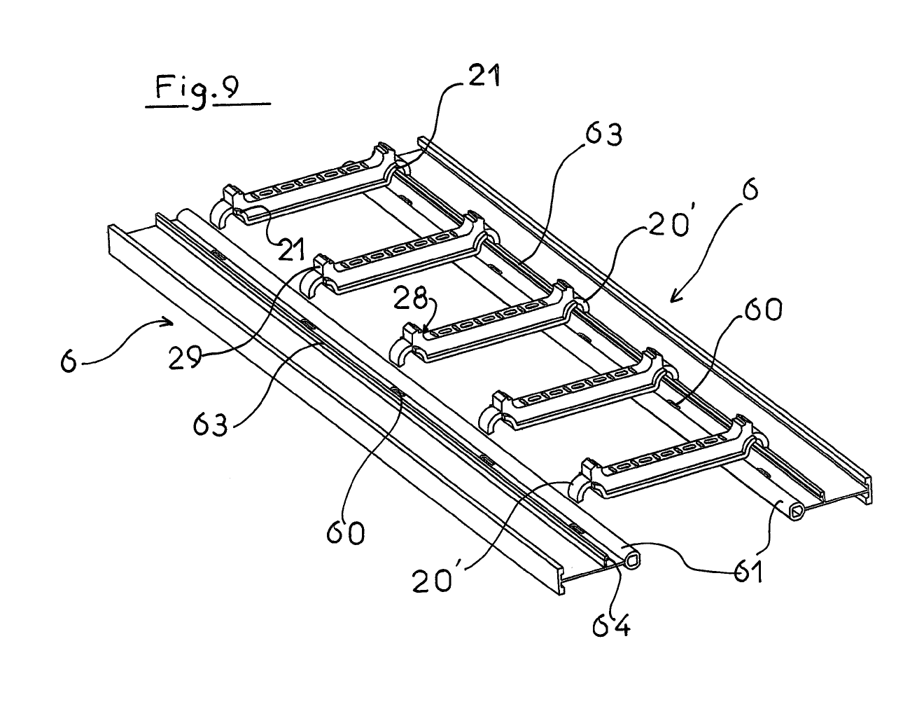

FIG. 7, FIG. 8 and FIG. 9 show a second embodiment of the device, in which the structure 1 comprises two side posts 6 made in a single piece by profile-shaping, which each appear as an elongated rectangular panel including windows 60 intended to closely receive the hooks 20′ of bars 20 forming the base 2 of the structure 1.

One of the longitudinal edges of each side post 6 is rounded and forms a longitudinal portion 61 forming the axis of rotation 30 about which the side post 6 pivots. The side post 61 delimits one of the sides of the windows 60, on which are engaged the free ends 20′ of the bars 20 of the base 2 hemmed into the windows 60 so as to secure the side posts 6 to the base 2, as this may be seen in FIG. 9, and to allow pivoting of the side posts 6 about the axis of rotation 30 relatively to the base 2.

Maintaining the side posts 6 in an angular position perpendicular to the base 2 is achieved by a tab 63 perpendicularly and longitudinally secured to the internal face of the side posts 6 which, when the side post 6 forms an angle of about 90° with the base 2, by its free longitudinal edge 64, will be snapped onto an anti-return abutment 27 made in a block 28 surmounting the external face of the free ends 20′ of the bars 20 and preventing the side post 6 from pivoting upon opening towards the outside of the structure 1.

The block 28 further includes a blocking abutment formed by a wall 29 perpendicular to the bar 20 against which the internal wall of the side post 6 will abut, when the latter forms an angle of 90° with the base 2 preventing the latter from pivoting upon closing beyond this angle towards the inside of the structure 1.

It may also be seen that the bars 20 in one of their alternative embodiments, have an omega-shaped cross-section integrating the stabilizers 21 at their free ends 20′, which stabilizers 21 have a rounded shape allowing them to fit the circular shape of the longitudinal edge 61 of a side post 6 upon which they will bear in order to reinforce the stability of the structure.

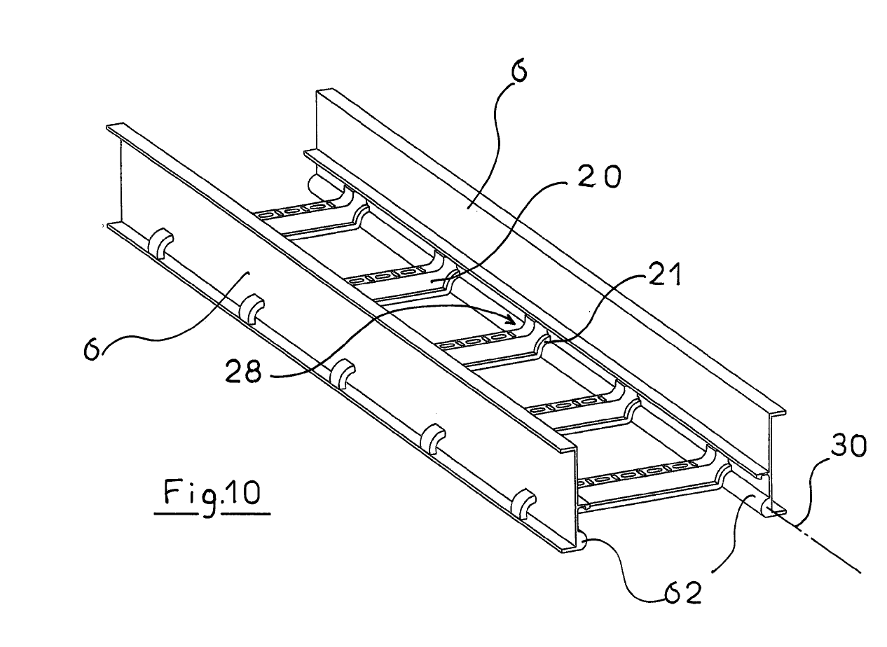

FIG. 10 shows an alternative of the side posts 6 made in a single piece, one 62 of the longitudinal edges of which forming the axis of rotation, is semi-circular inside the structure 1 of the cable route.

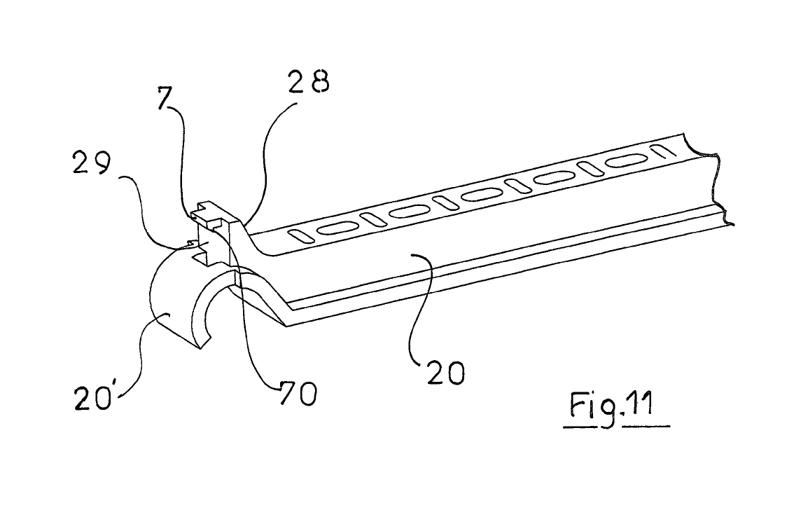

If reference is now made to FIG. 11, it may be seen that in an alternative of the side post 6 described in FIG. 7 and of the abutment and snapped-coupling devices, a free end 20′ of a bar 20 is surmounted with a block 28 consisting of a wall 29 perpendicular to the bar 20 and provided with a lug 7 including at the lower face of its free end a beveled edge 70 and intended to be engaged by snap-coupling into a slot, not shown, made in the wall of the side post 6 so that the edge of the slot will be inserted between the edge 70 and the vertical wall 29 which will have the effect of blocking the side post 6 in a position perpendicular to the base.

What is claimed is:

1. A device for routing and distributing electric cables, the device having an elongated shape (1) with a U-shaped cross-section including an assembly of two side posts (3) forming arms of the U-shaped cross section and a base (2) forming a bottom end of the U-shaped cross section, the assembly is made from at least one of a composite material or a strengthened plastic material, the device comprising:
at least one side post (3) including a longitudinal portion (31,61) having a partially circular cross-section and including windows (34,60), one edge of said windows adjacent said longitudinal portion (31,61) being delineated by said longitudinal portion;
said base including side extensions (20) forming rounded hooks (20′), the rounded hooks pivotally mounted around said longitudinal portion (31,61), said longitudinal portion forms an axis of rotation (30) for said side post (3) between a first position in which said side post is coplanar with said base (2) and a second position in which said side post (3) is perpendicular to said base (2), said longitudinal portion (31,61) and hooks (20′) thus forming a multiplicity of hinges; and
each of said windows (34,60) is dimensioned to tightly receive one hook (20′) therein when said side post is in said second position.

2. The device for routing cables according to claim 1, wherein said base has a first side, on which said side post extends when said side post is in said second position, and a second side opposite said first side, and wherein each hook comprises a rounded portion delineating a space adapted for the engagement of said hook onto said longitudinal portion, this space opening on said second side of the base.

3. The device for routing cables according to claim 1 wherein each hook comprises a rounded portion extending over more than 180° from a base portion by which said rounded portion is attached to said base, to a free end opposed to said base portion, said rounded portion being adapted to be engaged by snap-coupling on said longitudinal portion for securing said side post to said base.

4. The device for routing cables according to claim 1, further comprising snap-coupling devices (35,26,63,7) and abutment devices (22,23,26,27,29,38) capable of locking said side post in said second position.

5. The device for routing cables according to claim 4, wherein said abutment devices includes at least one blocking abutment (22,38,29) forming an obstacle to the rotation of the pivoting side post (3) preventing its rotation beyond an angle of about 90° with the base (2) and at least one antireturn abutment (23,26,27) which will engage by snap-coupling the snap-coupling devices and preventing the rotation of the side post (3) upon opening.

6. The device for routing cables according to claim 4, wherein the snap-coupling devices comprises first notches (26) arranged on the surface of said rounded portion of said hook delineating said space adapted for the engagement of said hook onto said longitudinal portion (31), and second notches (36) arranged on the surface of said longitudinal portion (31), said first and second notches (26, 36) being intended to be snapped onto each other as said side post (3) gradually rotates toward said second position, thus blocking said side post (3) in an angular position.

7. The device for routing cables according to claim 4, wherein the snap coupling devices comprise at least one flexible flexural tab (35,63) connected to said side post (3), and an anti-return abutment surface (23,27) on said base (2), said flexible flexural tab (35,63) being capable to elastically flex so as to slide over said anti-return abutment surface (23,27) when said side post (3) is moved toward said second position and to engage by snap-coupling against said anti-return abutment surface (23,27) when said side post is in said second position.

8. The device for routing cables according to claim 1, wherein a side post (3) is a single profile piece.

9. The device for routing cables according to claim 1, wherein a side post (3) side post includes at least two rods (31) and connecting parts (32) for rigidly connecting said rods (31).

10. The device for routing cables according to claim 9, wherein a connecting part (32) includes said window (34) intended to receive a side extension of said base.

11. The device for routing cables according to claim 2 wherein said rounded portion of each hook tapers from a base part of said rounded portion connected to said base to a free end of said rounded portion, and said base part is at least larger or thicker than a window (34) in said side post, thus allowing a play between said rounded portion and said window (34) when said side post (3) is in said first position and performing a tightening without any play between said rounded portion and said window (34) when said side post (3) is in said second position.

12. The device for routing cables according to claim 1, wherein the base (2) comprises a succession of bars (20) perpendicular to the longitudinal axis (1′) of the cable route (1) and the side extensions (20′) of the base (2) are formed by the free ends of said bars (20).

13. The device for routing cables according to claim 12, wherein the bars (20) are made by assembling a body-forming portion and at least one added end portion forming the side extension.

14. The device for routing cables according to claim 12, wherein the bars (20) include side stabilizers (21) bearing upon a surface of the pivoting side post allowing the bars (20) to be blocked perpendicularly to the longitudinal axis of the cable route and preventing any longitudinal deformation of the latter during use.
